(19) United States
(12) Patent Application Publication
(10) Pub. No.: US 2004/0145243 A1
(43) Pub. Date: Jul. 29, 2004

(54) Power generating unit with a generator

(76) Inventors: Richard Blatter, Schaffhausen (CH); Hans-Werner Schlett, Waldshut (DE); Mathias Wittwer, Zuerich (CH); Oliver Luder, Kuesnacht (CH); Peter Vogler, Zuerich (CH)

Correspondence Address: ADAM J. CERMAK, LAW OFFICE OF ADAM J. CERMAK, P.O. BOX 7518, ALEXANDRIA, VA, 22307-7518, US

(21) Appl. No.: 10/386,678

(22) Filed: Mar. 13, 2003

(30) Foreign Application Priority Data
Mar. 13, 2002 (CH) 2002 0441/02

(51) Int. Cl. H02J 9/00; H02J 7/00

(52) U.S. Cl. 307/64

(57) ABSTRACT

In a power generating unit a high power generator (28) is connected to a main transformer (29) or grid by means of a generator bus bar (11). A plurality of main current carrying parts (12, 15, 17) and protection and/or excitation circuits (13,14, 16; 18-24) are arranged along the generator bus bar (11) between the generator (28) and the main transformer (29). A simplified and fault-protected assembly is achieved by integrating the main current carrying parts (12, 15, 17) and the protective and/or excitation circuits (13, 14, 16; 18-24) into one generator power module (10).

This application claims priority under 35 U.S.C. § 119 to Swiss patent application number 2002 0441/02, filed Mar. 13, 2002, the entirety of which is incorporated by reference herein.

### FIELD OF INVENTION

The present invention is relevant to the field of power generation. It relates to a power generating unit with a generator according to the preamble of claim 1.

### PRIOR ART

In the power generating unit of a power plant it is conventional to connect a high power generator to the power supply grid by way of a generator bus bar and a main transformer. Along the generator bus bar various components are disposed between the generator and the main transformer. These include both the main current carrying parts and associated protection and excitation circuits.

Pages 393 to 395 of the ABB Handbook of Switch Stations, 9^{th} ed. (1994) illustrate the design of such a generator assembly. It can be seen that all of the components (voltage transformer box, excitation transformer, generator circuit breaker, system-supply transformer, ground circuit, etc.) are installed separately within the building structure; these may include all or only a portion of the components shown in FIGS. 9-6. In addition to these components are also protective, control, measuring and exciter cabinets. The latter are also closely tied to the functioning of the generator assembly, but generally are installed separately in rooms far-removed. An arrangement of this kind is time-consuming and it requires costly on-site, large-scale assembly, wiring, testing and start-up.

### BRIEF DESCRIPTION OF THE INVENTION

Thus, the object of the present invention is to design a power generating unit of the aforementioned kind that eliminates the drawbacks of prior art solutions and which, in particular, reduces the cost of assembly and testing, and reduces or fully eliminates assembly errors.

The object is achieved by means of all the features set forth in claim 1. By spatially integrating the system's main current carrying components and protective and/or excitation circuits in accordance with the present invention into a power generator module, a simplified system design is achieved with substantial reduction in the occurrence of assembly errors. It is especially advantageous if the individual components of the generator power unit are pre-assembled in subunits, such subunits then being combined to form the generator power unit.

The generator power module preferably comprises a generator circuit breaker and control circuits associated with said circuit breaker, an in-line circuit breaker, a starting circuit breaker and a ground circuit breaker, an excitation circuit connected via an excitation transformer to the generator bus bar, in addition to a generator and system protection device.

### BRIEF DESCRIPTION OF THE DRAWINGS

Preferred embodiments of the present invention are described in greater detail with reference to the drawings, in which:

FIG. 1 is a simplified schematic diagram of a power generating unit according to a preferred embodiment of the present invention;

FIG. 2 is a side view of an exemplary spatial arrangement of a power generating unit according to the present invention;

### WAYS OF IMPLEMENTING THE INVENTION

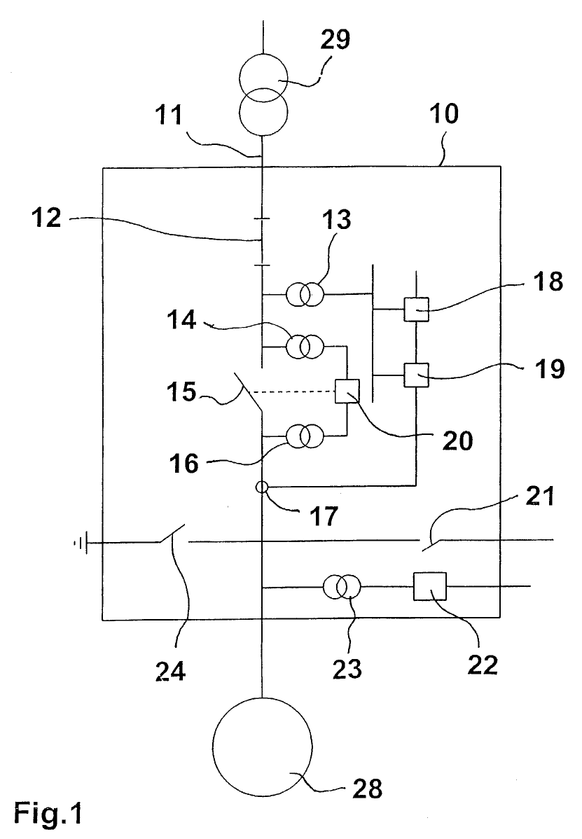

FIG. 1 shows a simplified circuit diagram of a power generating unit according to a preferred embodiment of the present invention. The power generating unit comprises a high power generator 28, driven, e.g. by a gas or steam turbine, and connected by a generator bus bar 11 to a main transformer 29. Integrated in the generator bus bar 11 are an in-line circuit breaker 12, a generator circuit breaker 15 and a current transformer 17. Connected to the generator bus bar 11 is a ground connection with a ground circuit breaker 24, a starting connection with a starting circuit breaker 21, an excitation circuit 22 by way of an excitation transformer 23 and multiple voltage transformers 13, 14 and 16. The voltage transformer 13 supplies, for example, a transducer 18 and a generator and system protection circuit 19, the one input of which is connected to the current transformer 17. The aforementioned main current carrying parts and the protection and excitation circuits are integrated spatially into a generator power module 10. It is understood that in addition to the parts and systems enumerated herein, it is feasible to add further parts and systems to the generator power module 10. It is also contemplated that only a portion of the enumerated parts and systems may be integrated into a generator power module.

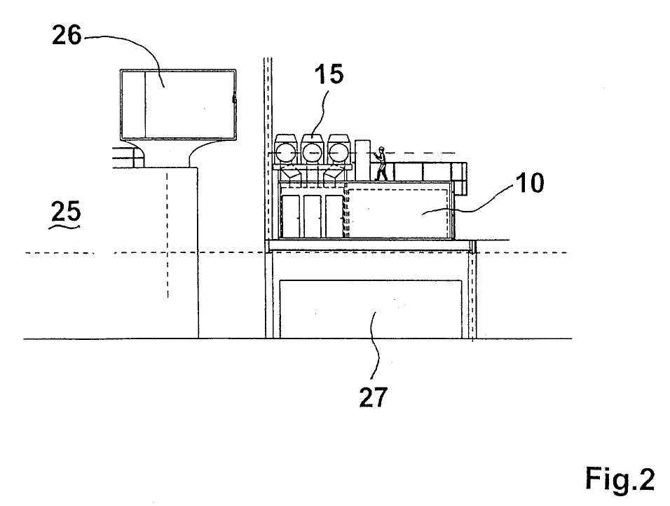

The requisite components of the generator power module 10 are mounted as subunits in supports that are encased where required, and if necessary, ventilated, air-conditioned or heated, or are at the very least pre-assembled at a plant so that they may be precisely fitted together at the construction site. Where suitable transport means permit it, such systems may also be integrated directly in the generator. Once assembled, the components define a compact generator power module 10, as designed in FIG. 2 next to the generator 25 and its associated air intake filter 26. It is feasible, for example to locate a starter module 27 beneath the elevated generator power module 10.

This design method reduces to a minimum the time required for assembly at the construction site, a factory-conducted pre-inspection reduces considerably the frequency of errors. Moreover, highly functional electrical connections may be securely installed so as to prevent mistaken contact as a result of confusion, because the connections are run and are accessible only within the limited space of the generator power module.

A potential model inspection of a unit of this type also facilitates any approval procedures by local authorities.

### List of Reference Numerals

10 generator power module

11 generator bus bar

12 in-line circuit breaker

13,14,16 voltage transformer

15 generator circuit breaker

17 current transformer

18 transducer

19 generator and system protective device

20 synchronization device

21 starting circuit breaker

22 excitation device (and voltage regulator)

23 excitation transformer

24 ground circuit breaker

25 generator

26 air intake filter

27 starter module

28 generator

29 main transformer

We claim:

1. A power generating unit useful for connection to a main transformer or grid, the power generating unit comprising:
a high power generator;
a generator bus bar for connecting the generator to the main transformer or grid;
a plurality of main current carrying parts, and protection circuits, excitation circuits, or both, arranged at the generator bus bar between the generator and the main transformer when connected thereto;
wherein the main current carrying parts and the protection circuits, excitation circuits, or both are spatially integrated into one generator power module.

2. A power generating unit according to claim 1, wherein the generator power module includes a generator circuit breaker and control circuits associated with said generator circuit breaker.

3. A power generating unit according to claim 2, wherein the generator power module includes an in-line circuit breaker, a starting circuit breaker, and a ground circuit breaker.

4. A power generating unit according to claim 2, wherein the generator power module includes an excitation device and an excitation transformer, the excitation transformer connecting the excitation device to the generator bus bar.

5. A power generating unit according to claim 2, wherein the generator power module includes a generator and system protection device.

6. A power generating unit according to claim 1, wherein the individual components of the generator power module are pre-assembled in subunits, said subunits being combined to form the generator power module.

7. A system comprising:
a power generating unit according to claim 1; and
a main transformer connected to the power generating unit.

8. A system comprising:
a power generating unit according to claim 1; and
a grid connected to the power generating unit.
